(19) United States
(12) Patent Application Publication
(10) Pub. No.: US 2007/0282680 A1
(43) Pub. Date: Dec. 6, 2007

(54) Systems and methods for providing an electronic channel for content generation and delivery

(76) Inventors: Corey T. Davis, Cedar Hills, UT (US); Richard G. Tripp, Cedar Hills, UT (US)

Correspondence Address: KIRTON AND MCCONKIE, 60 EAST SOUTH TEMPLE,, SUITE 1800, SALT LAKE CITY, UT, 84111, US

(21) Appl. No.: 11/444,896

(22) Filed: May 31, 2006

(51) Int. Cl. G06Q 30/00

(52) U.S. Cl. 705/14

(57) ABSTRACT

Systems and methods for creating and delivering high quality, high value content from among an electronic community of authors, wherein collaboration is enabled and the content is specific to purchasers of the content. A platform for an online collaboration marketplace is created to enable the generation and delivery of high value, high quality content that is specific to its purpose. Users enter the online marketplace to seek desired content. Such content is created by an author base and is made available for user purchase and/or delivery. The author base includes a variety of authors, wherein each of the authors is rated to inform the user of the reliability of the content that is available for purchase and/or delivery. A user requests specific content. The request may be joined by one or more other requests. Any of the plurality of authors that satisfy the request may elect to create the requested content. Moreover, a plurality of authors may collaborate to create the requested content. Such collaboration adds value to the authored work. Once created, the requested content is made available to the user for purchase and delivery.

### BACKGROUND OF THE INVENTION

1. Field of the Invention

The present invention relates to providing an electronic channel for content generation and delivery. In particular, the present invention relates to systems and methods for creating and delivering high quality, high value content from among an electronic community of authors, wherein collaboration is enabled and the content is specific to purchasers of the content.

2. Background and Related Art

With the advancement of the computer industry and the emergence of the internet, electronic data has become increasingly available. Searches of electronic data performed by users routinely take place. For example, a computer user is able to utilize one or more search engines to receive search results that may be examined or otherwise explored by the user. While this searching technique may provide search results to the user, the specific results received may not include information that is deemed valuable or otherwise desirable to the computer user.

When performing one or more searches based upon a research project, for example, the information can prove to lack the specificity required for the research project. As a result, computer users can invest large amounts of time sifting through search results in hopes to find desired information. Such investments of time can prove to be fruitless for the user.

The quality and/or reliability of the information obtained from a search may be questioned by the user. At times the user is unaware of the author of the electronic data, which was obtained through the search. Alternatively, the electronic data may identify the author but the user is unfamiliar with the author and the reputation of the author. As such, the user has no way of knowing the reliability of the electronic data obtained.

Thus, while techniques currently exist that are used to obtain electronic data, challenges still exist, including the obtaining of electronic data that is not specific, desirable, and/or reliable. Accordingly, it would be an improvement in the art to augment or even replace current techniques with other techniques.

### SUMMARY OF THE INVENTION

The present invention relates to providing an electronic channel for content generation and delivery. In particular, the present invention relates to systems and methods for creating and delivering high quality, high value content from among an electronic community of authors, wherein collaboration is enabled and the content is specific to purchasers of the content.

Implementation of the present invention takes place in association with systems and methods that embrace economic incentive coupled with collaboration to provide a platform for an online collaboration marketplace to enable the generation and delivery of specific, high value, high quality content. The platform brings authors and buyers together to accomplish such generation and delivery of content.

One example of content is an electronic article. Users enter the online marketplace to seek articles. Such articles are created by an author base and made available for user purchase and/or delivery. The author base includes a variety of authors, wherein each of the authors is rated, such as by other users, to inform the user of the reliability of the content that is available for purchase and/or delivery.

If the desired information cannot be found, wherein the desirability may be a function of the format, orientation, applicability, length, and academic level at which the information was created, a user may make a request for specific content that suits the user's purpose. If the request is similar to other requests that have been made by other users, the user has the option to unite his/her request with the requests of other users. These requests are made available to the established author base. The request can include required demographics of the authors who create the requested content. Any of the plurality of authors that satisfy the request may elect to create the requested content. Furthermore, a plurality of authors may collaborate to create the requested content. Such collaboration adds value to the authored work. Once created, the requested content is made available to the user for purchase and delivery.

While the methods and processes of the present invention have proven to be particularly useful in the area of electronic articles, those skilled in the art will appreciate that the methods and processes of the present invention embrace a variety of different electronic content. Examples of such content include articles, screen plays, poems, skits, books, music, pictures, graphics, logos, games, lyrics, speeches, papers, applications, music, and/or any other type of content that can be placed in the form of electronic content. Moreover, the methods and processes of the present invention embrace content relating to a variety of industries (e.g., the healthcare industry, education industry, legal industry, banking and/or finance industry, automotive industry, technology industry, the sciences, politics, and/or any other industry) and/or interests or other topics (e.g., adventure, architecture, animals, art, biographies, boats, business, cars, children, Christianity, class notes, crafts, culinary arts, book reviews, communications, computer science, cooking, counseling, crafts, current events, diet, health, education, engineering, entertainment, fantasy, fashion, food, gardening, genealogy, high-tech, history, hobbies, home decor, hobbies, how to, humor, languages, landscaping, law, math, mechanics, medical, news, novels, painting, personal care, pets, philosophy, poems, professional, professional skills, product reviews, programming, religion, remodeling, research papers, science, science fiction, screenplays, self-help, short stories, software development, spirituality, sports, technology, time management, top 10, travel, writing and/or any other topic).

These and other features and advantages of the present invention will be set forth or will become more fully apparent in the description that follows and in the appended claims. The features and advantages may be realized and obtained by means of the instruments and combinations particularly pointed out in the appended claims. Furthermore, the features and advantages of the invention may be learned by the practice of the invention or will be obvious from the description, as set forth hereinafter.

### BRIEF DESCRIPTION OF THE DRAWINGS

In order that the manner in which the above recited and other features and advantages of the present invention are obtained, a more particular description of the invention will be rendered by reference to specific embodiments thereof, which are illustrated in the appended drawings. Understanding that the drawings depict only typical embodiments of the present invention and are not, therefore, to be considered as limiting the scope of the invention, the present invention will be described and explained with additional specificity and detail through the use of the accompanying drawings in which:

FIG. 1 illustrates a representative computer device for use in association with embodiments of the present invention;

FIG. 2 illustrates a representative system that provides a suitable operating environment for embodiments of the present invention;

FIG. 3 illustrates a representative embodiment for content generation and delivery;

FIG. 4 illustrates a representative embodiment for generating or authoring content and setting up relationships within an author base; and

FIG. 5 illustrates a representative embodiment for delivering content and allocating the fees received for the delivery of the content.

### DETAILED DESCRIPTION OF THE INVENTION

The present invention relates to providing an electronic channel for content generation and delivery. In particular, the present invention relates to systems and methods for creating and delivering high quality, high value content from among an electronic community of authors, wherein collaboration is enabled and the content is specific to purchasers of the content.

Embodiments of the present invention take place in association with systems and methods that embrace economic incentive coupled with collaboration to provide an online collaborative platform, channel or marketplace to enable the generation and delivery of high value, high quality content that is specific to its purpose. The online platform, channel or marketplace brings authors and buyers together to accomplish such generation and delivery of content. For example, the online platform, channel or marketplace allows authors to market their content to buyers and to find and collaborate with other authors to improve their content. When collaborative content is created, each author is provided a share of the purchase price through the system, and links are available to other content of the author or related content by other authors.

In addition, the online channel or marketplace that allows buyers to find, purchase, and read high-value content that is written to near-professional standards, and to make requests to the author community for content that the buyer is unable to locate and specify the amount that they would be willing to pay for the content. The online channel or marketplace also enables marketers to find top-selling content artifacts which they can embed highly specific advertisements.

The following disclosure of the present invention is grouped into two subheadings, namely “Exemplary Operating Environment” and “Content Generation and Delivery.” The utilization of the subheadings is for convenience of the reader only and is not to be construed as limiting in any sense.

### Exemplary Operating Environment

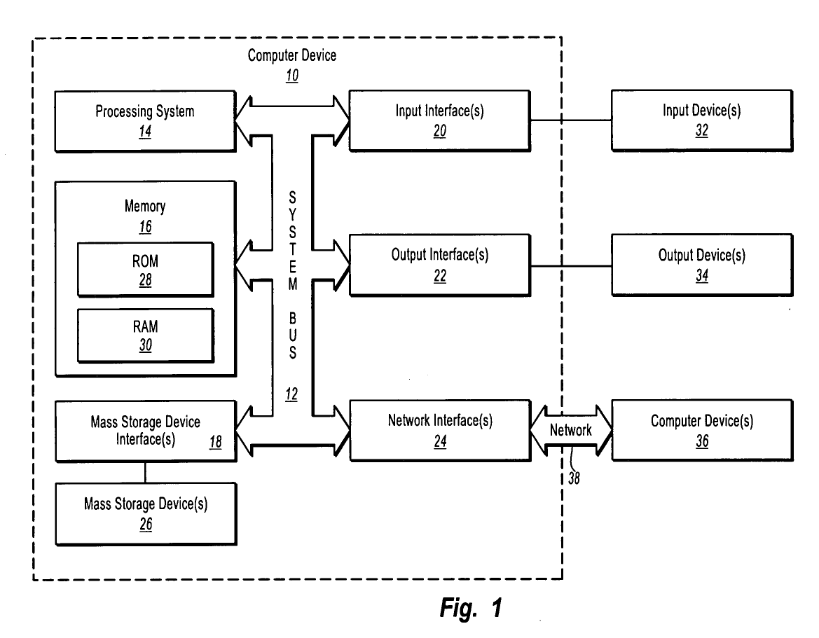

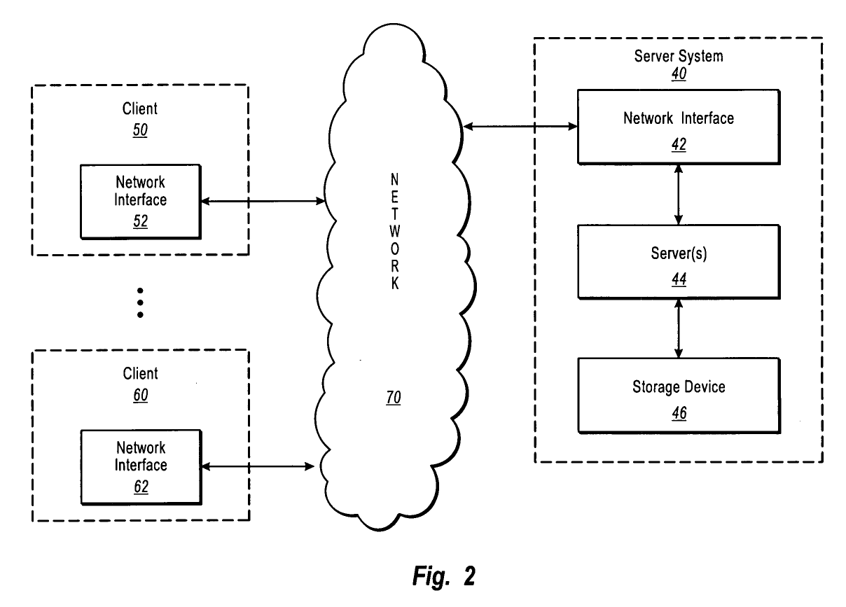

Embodiments of the present invention take place in association with one or more computer devices for use within a system that provides an electronic channel for content generation and delivery. Accordingly, FIGS. 1 and 2, and the corresponding discussion, are intended to provide a general description of a suitable operating environment in which the invention may be implemented. One skilled in the art will appreciate that the invention may be practiced by one or more computing devices and in a variety of networked configurations.

Embodiments of the present invention embrace one or more computer readable media, wherein each medium may be configured to include or includes thereon data or computer executable instructions for manipulating data. The computer executable instructions include data structures, objects, programs, routines, or other program modules that may be accessed by a processing system, such as one associated with a general-purpose computer capable of performing various different functions or one associated with a special-purpose computer capable of performing a limited number of functions. Computer executable instructions cause the processing system to perform a particular function or group of functions and are examples of program code means for implementing steps for methods disclosed herein. Furthermore, a particular sequence of the executable instructions provides an example of corresponding acts that may be used to implement such steps. Examples of computer readable media include random-access memory (“RAM”), read-only memory (“ROM”), programmable read-only memory (“PROM”), erasable programmable read-only memory (“EPROM”), electrically erasable programmable read-only memory (“EEPROM”), compact disk read-only memory (“CD-ROM”), or any other device or component that is capable of providing data or executable instructions that may be accessed by a processing system.

With reference to FIG. 1, a representative system for implementing the invention includes computer device 10, which may be a general-purpose or special-purpose computer. For example, computer device 10 may be a personal computer, a notebook computer, a personal digital assistant (“PDA”) or other hand-held device, a workstation, a minicomputer, a mainframe, a supercomputer, a multi-processor system, a network computer, a processor-based consumer electronic device, or the like.

Computer device 10 includes system bus 12, which may be configured to connect various components thereof and enables data to be exchanged between two or more components. System bus 12 may include one of a variety of bus structures including a memory bus or memory controller, a peripheral bus, or a local bus that uses any of a variety of bus architectures. Typical components connected by system bus 12 include processing system 14 and memory 16. Other components may include one or more mass storage device interfaces 18, input interfaces 20, output interfaces 22, and/or network interfaces 24, each of which will be discussed below.

Processing system 14 includes one or more processors, such as a central processor and optionally one or more other processors designed to perform a particular function or task. It is typically processing system 14 that executes the instructions provided on computer readable media, such as on memory 16, a magnetic hard disk, a removable magnetic disk, a magnetic cassette, an optical disk, or from a communication connection, which may also be viewed as a computer readable medium.

Memory 16 includes one or more computer readable media that may be configured to include or includes thereon data or instructions for manipulating data, and may be accessed by processing system 14 through system bus 12. Memory 16 may include, for example, ROM 28, used to permanently store information, and/or RAM 30, used to temporarily store information. ROM 28 may include a basic input/output system (“BIOS”) having one or more routines that are used to establish communication, such as during start-up of computer device 10. RAM 30 may include one or more program modules, such as one or more operating systems, application programs, and/or program data.

One or more mass storage device interfaces 18 may be used to connect one or more mass storage devices 26 to system bus 12. The mass storage devices 26 may be incorporated into or may be peripheral to computer device 10 and allow computer device 10 to retain large amounts of data. Optionally, one or more of the mass storage devices 26 may be removable from computer device 10. Examples of mass storage devices include hard disk drives, magnetic disk drives, tape drives and optical disk drives. A mass storage device 26 may read from and/or write to a magnetic hard disk, a removable magnetic disk, a magnetic cassette, an optical disk, or another computer readable medium. Mass storage devices 26 and their corresponding computer readable media provide nonvolatile storage of data and/or executable instructions that may include one or more program modules such as an operating system, one or more application programs, other program modules, or program data. Such executable instructions are examples of program code means for implementing steps for methods disclosed herein.

One or more input interfaces 20 may be employed to enable a user to enter data and/or instructions to computer device 10 through one or more corresponding input devices 32. Examples of such input devices include a keyboard and alternate input devices, such as a mouse, trackball, light pen, stylus, or other pointing device, a microphone, a joystick, a game pad, a satellite dish, a scanner, a camcorder, a digital camera, and the like. Similarly, examples of input interfaces 20 that may be used to connect the input devices 32 to the system bus 12 include a serial port, a parallel port, a game port, a universal serial bus (“USB”), a firewire (IEEE 1394), or another interface.

One or more output interfaces 22 may be employed to connect one or more corresponding output devices 34 to system bus 12. Examples of output devices include a monitor or display screen, a speaker, a printer, and the like. A particular output device 34 may be integrated with or peripheral to computer device 10. Examples of output interfaces include a video adapter, an audio adapter, a parallel port, and the like.

One or more network interfaces 24 enable computer device 10 to exchange information with one or more other local or remote computer devices, illustrated as computer devices 36, via a network 38 that may include hardwired and/or wireless links. Examples of network interfaces include a network adapter for connection to a local area network (“LAN”) or a modem, wireless link, or other adapter for connection to a wide area network (“WAN”), such as the Internet. The network interface 24 may be incorporated with or peripheral to computer device 10. In a networked system, accessible program modules or portions thereof may be stored in a remote memory storage device. Furthermore, in a networked system computer device 10 may participate in a distributed computing environment, where functions or tasks are performed by a plurality of networked computer devices.

While those skilled in the art will appreciate that embodiments of the present invention may be practiced in network computing environments with many types of computer system configurations to provide an electronic channel for content generation and delivery, FIG. 2 provides a representative configuration that includes two clients connected to a server system, wherein each client is a computer device.

Those skilled in the art will appreciate that alternative embodiments include one client connected to a server system or more than two clients connected to a server system. Moreover, embodiments in accordance with the present invention also include a multitude of clients throughout the world connected to a network, where the network is a wide area network, such as the Internet. Further, the server system may include a single server in cases where a single server can process and preserve the entire amount of information required to perform the methods of the present invention that are disclosed herein. Alternatively, the server system may be a conglomeration of servers that process and preserve a high volume of information. Moreover, embodiments of the present invention embrace system configurations that are not based on a client-server relationship, including peer-to-peer relationships, and/or other computer system configurations.

In FIG. 2, a computer system configuration is illustrated that includes server system 40 connected to clients 50 and 60 via a network 70. Those skilled in the art will appreciate that network 70 may include a wide area network (e.g., the internet), a local area network, a leased line connection, a wireless network, a dial up connection, and/or any other type of connection that enables information to be exchanged between server system 40 and clients 50 and 60.

Server system 40, client 50, and client 60 each include a network interface (respectively illustrated as network interfaces 42, 52, and 62) that enables information to be exchanged or communicated. Server system 44 also includes one or more servers that selectively manage data, which is preserved at and/or obtained from a storage device 46.

Accordingly, a user at client 50 is able to enter the online marketplace to seek desired content that is created by an author base and is made available for purchase and/or delivery. As shall be further discussed below, a user at client 50 makes a request for specific content. That request may be joined to one or more other requests by the user, another user, and/or the system 40 and made available to an established author base. In the illustrated embodiment, an author at client 60 that satisfies the requirements of the request can obtain the request and author and/or collaborate in authoring the content, which is then made available through the system 40 to the user at client 50 for purchase and/or delivery.

In at least some embodiments, software modules for use on a computer device or system are provided relating to the user registration, visitors, article sales, article authoring, community collaboration, payment gateway integration, etc. A user registration module addresses inputs from individual users, personal data of the users, payment information, areas of expertise, user profile or homepage creation supported as a sub domain, and/or customization of home pages for the registered users. A visitor module focuses on searching for articles, such as by filtering through the utilization of tags, browsing through articles, requesting for articles, voting on articles, waiting articles, and other information. Article sales modules focus on searching for articles, such as through the utilization of tags, browsing through articles, purchasing articles, voting on articles and/or waiting articles. An article authoring module focuses on browsing the requests, responding to requests, creating and publishing articles through an editor tool, inviting friends or groups for a free initial preview of articles that have been authored, and/or providing price set up to include pricing for authoring, buyer price and referrals and other services.

A community collaboration module focuses on inviting other registered authors to collaborate with the created article, accepting and collaborating on the articles for which the author receives the invitation. A payment gateway integration module focuses on the collection process for insertion, preview and buying through a payment system. A module focuses on how many times the article has been sold, how much money it made off an article, how much money it made from the system, the data export of the article sales through the system, and/or removal of idle articles from the system.

### Content Generation and Delivery

As provided herein, embodiments of the present invention relate to providing an electronic channel for content generation and delivery. In particular, embodiments of the present invention relate to creating and delivering very specific, high quality, high value content from among an electronic community of authors, wherein collaboration is enabled and the content is specific to purchasers of the content.

In accordance with embodiments of the present invention, content is made available for delivery and/or purchase. A portal, channel, and/or electronic community is provided where authors collaboratively come together and create high quality, high value content that is very specific to those who are going to buy the content. Deregulating the flow of information occurs, wherein individuals of the author base contribute their own individual areas of expertise and dramatically improve the content. The author base further includes individuals with experience and/or skills that enable the creation of content. For example, at least some individual authors are amateurs that participate through the system in collaborating and ultimately creating content that is of professional quality or better. Incentives are provide to collaborate and create high value content for users.

Users enter the system to obtain content. The system satisfies information requests for popular information, and is particularly suited to information requests in that come from market demand. As provided herein, a user enters the system and place a request for content.

As an example, Glen, an individual from Nevada, needs information on how to change the transom on a 1969 Bayliner boat, his latest restoration project. He can't find local boat mechanics in his home state that know how it is to be done and there is limited information about the part in general, much less where to find a new one and how to make the switch. Glen is willing to pay for instructions that would walk him step-by-step through the process. Glen goes to the system and creates a detailed content request and specifies how much money he would be willing to pay.

Nick lives in Michigan and knows exactly what Glen needs to know to change the transom on the 1969 Bayliner boat. Nick authors the document and finds Debbie, an editor, through the system who is looking for work and hires Debbie to clean the document up and incorporate some nice images that Nick has on hand. Nick grants Debbie access to the written article. After the article is published, Debbie receives ten percent of every sale of the article through the system for her services.

As another example, Kim indicates in a request that she is a 37-year-old married woman that stays at home with her five kids and her husband, Steve, works for the phone company making $48,000 a year. Kim manages their family finances and never feels like they are able to get on top of things. They usually have $10,000 or more in credit card debt, with a credit rating that is starting to suffer—recently dipping below 650. They have tried to use budgets, have bought financial management software, and have even read a couple of books on how to get ahead financially, but nothing seems to work. Kim doesn't feel like they live an extravagant lifestyle, as they only camp on vacations and their kids wear second-hand clothing. They rarely date or eat out, and are starting to get desperate.

Kim indicates in the request that she wants content written by authors who can relate to her circumstance. She was turned off by available books because she didn't feel like the people writing them were able to relate to the pressures and difficulties of her situation. She can't afford much, but would be willing to buy an article that was written by several stay-at-home moms like her, in similar circumstances, who feel like they've actually found some keys to improving their situation. They are on top of their finances, feel in control of their lives, feel emotionally healthy, etc.

Rather than so called “experts,” Kim is interested in other moms who have practical knowledge of how to face the challenges that Kim faces. While no mother may have all of the answers, various mothers can collaborate in sharing things that worked for them. Kim would be willing to pay $5 for the content. Such a request could prove valuable to the authors as others in similar situations may be willing to pay a similar amount for the content.

Thus, a user enters the system and makes a request for content. Other users enter the system and can make similar requests. A query or customized search is made through the system that compares their query to other content requests. The opportunity is then given to join or add comments to a previous request. The increase in number of a particular request makes the request more desirable for the authoring of content because there are increased numbers of users who are ready and willing to purchase the content. Accordingly, a marketplace is created that balances demand and it helps authors gauge what buyers truly want.

For example, Liz, a young mother from Boston, who is trying to cope with the various responsibilities of raising a family and balancing demands of time requests an article that is authored by at least 30 mothers near her geographical location that have a similar income and situation to her on the topic of the top ten biggest struggles of the authors, how they cope, and lessons they have learned. Her request is joined by 25 other young mothers in a similar situation. Such specific content provides high value for Liz and the other mothers that can improve their lives, and as a result they are willing to pay for the article.

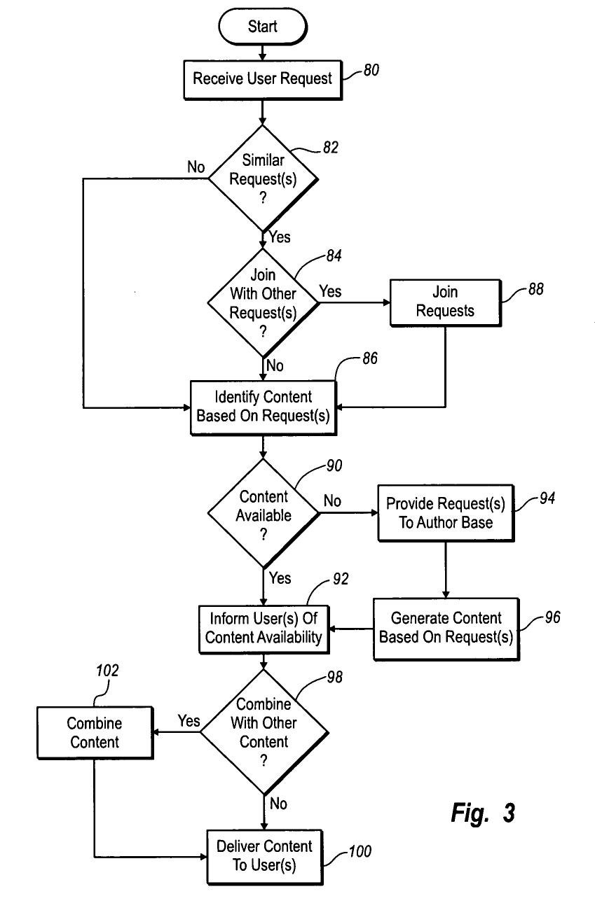

With reference now to FIG. 3, a representative embodiment is illustrated for content generation and delivery. In FIG. 3, execution begins at step 80 where a user request is received by the system. The user request is a request for content that may be purchased or otherwise used by the user. At decision block 82 a determination is made as to whether or not there exist similar requests that have been submitted by one or more other users. If it is determined at decision block 82 that no other similar request has been received by the system, execution proceeds to step 86 for the identification of content based on the request received by the user. Alternatively, if it is determined at decision block 82 that similar requests have been received by the system from one or more users, execution proceeds to decision block 84 for determination as to whether or not to join the present request with one or more other user requests. If it is determined at decision block 84 that the present user request is not to be joined with any other user request then execution proceeds directly to step 86 for the identification of content based on the user request. Alternatively, if it is determined at decision block 84 to join the present request with one or more other user requests, execution proceeds to step 88. At step 88 the request are joined and execution then proceeds to step 86 for the identification of content based on the requests.

Once the content has been identified based upon the requests received by the users, as provided for by step 86, execution proceeds to decision block 90. At decision block 90 a determination is made as to whether or not content is available that satisfies the user requests. If it is determined at decision block 90 that content is available, execution proceeds to step 92 to inform the user of the content availability. Alternatively, if it is determined at decision block 90 that the content relative to the user request is not available, execution proceeds to step 94. At step 94 the user requests are provided to the author base of the system. The author base is an electronic community of authors available to submit content for purchase or otherwise use by one or more users of the system. After the requests are provided to the author base at step 94, execution proceeds to step 96 where the content is generated based upon the requests received from the users. Execution then proceeds directly to step 92, where the users are informed of the content availability.

Once the users are informed of the content availability at step 92, execution proceeds to decision block 98 for determination as to whether or not to combine the available content with any additional content. In accordance with embodiments of the present invention, content may be combined with other content based upon user requests, recommendations by the system, specials identified by the system, or for other reasons. If it is determined at decision block 98 that the content is not to be combined with other content execution proceeds to step 100 for delivery of the content to the users. Alternatively, if is determined at decision block 98 that the content is to be combined with other content of the system, execution proceeds to step 102 where the content is combined and then execution proceeds to step 100 for the delivery of the content to the users.

Through the system authors are able to come in and mine the content request area to find the content requests that have received particular interest from buyers. Accordingly, when it comes time to create and sell the content there is already a willing user base to purchase the content.

For example, Scott is preparing for his MBA and wants more than the traditional GMAT preparation courses that are being offered. He makes a detailed content request indicating that he would pay $200 for an article that is collaboratively written by five or more people who scored more than 740 on the GMAT, wherein the article is focused specifically to how they prepared for the GMA7 exam.

Jeron scored 744 on the GMAT and has seven friends who scored a 740 or higher. They studied together and kept all of their notes. Jeron starts an article and invites his seven friends to collaborate, offering each a five percent share of each article sale. After the article is written, Jeron uses the system to contact Scott and other users who have made similar requests to let them know that the article is available for purchase and delivery.

In another example, Derek, a senior product manager for a software company, makes inventory management solutions for small businesses. He is willing to pay $4,000 for a report that clearly illustrates the purchasing processes of 25 different small businesses. Amber, a free-lance researcher, is connected to several small businesses in her community. Amber organizes a survey, recruits 25 small business people to participate, and compiles the results in an article. She invites four others who have written on inventory management topics to collaborate on the article, sharing their perspective and expertise on her findings. Amber offers each a $50 share of the article when it sells. Once created, Amber uses the system to contact Derek and other users who joined his request. The users then buy access to the created content.

Thus, embodiments of the present invention create a collaboration platform. Additionally, a social networking aspect exists. The system enables an author to start on the article, name it, and involve others. Similar to the way the system conducts a query for the content request and then shows the content requester that there is a similar looking request that they might want to join, the system also shows authors that there are other people who are trying to write articles about this topic. Do you want to compete against them or would you like to invite them to collaborate with you? As a result, a plurality of authors work together to produce a much better piece of electronic content that is more appealing to buyers. Accordingly, a platform is provided by the system to find similar articles and set up relationships with other authors in the electronic community.

In one embodiment, a home page is designed for every author in the electronic community. On that page the author lists the content authored, the content purchased, skills available for collaboration, and other useful information. For example, an author may indicate on her home page that she is an expert in home decor and a ghost writer by night. She has a really good editorial hand and so sometimes people come to her and give her content that she really doesn't know much about, but because she is a really good writer she can pull it all together and make it look good and sound smart.

And in addition, on the author's home page buyers and other authors come and rank the author based on their experience of working with and/or buying content from the author. Additionally, comments can be provided on the author by the buyers and other authors. This provides increased information for new buyers of the author's content and other authors who may collaborate with this author.

In one embodiment, every user exists as an object in a database. Each user has multiple properties, and some of the properties embrace that the user is an author and the areas of expertise of the user. As a result, a query can match profiles of users to enable collaboration with these people.

Accordingly, embodiments of the present invention embrace the finding of similar articles being authored to enable collaboration and/or interfacing between individuals having particular expertise. Each individual can check out the other's home page profile to determine whether or not to collaborate. Each individual can review the other's description, resume, content authored, credentials, and reputation.

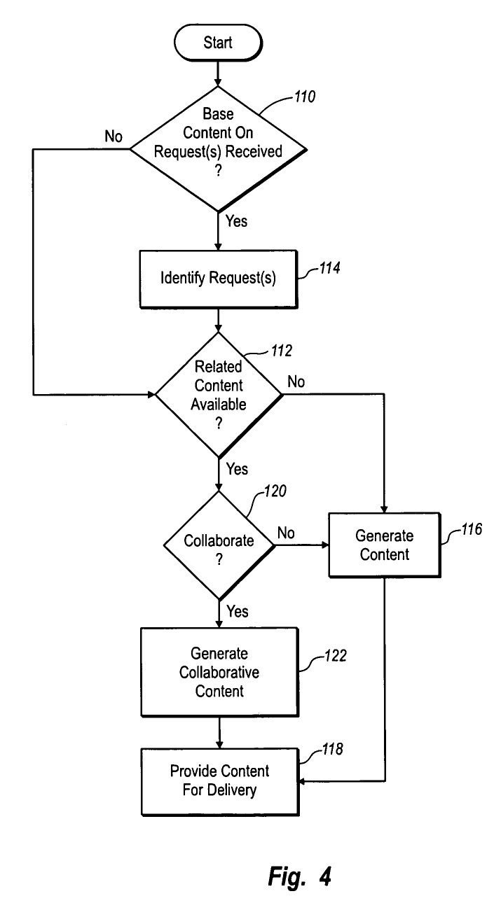

With reference to FIG. 4, a representative embodiment is illustrated for generating and/or authoring content and/or setting up relationships within an author base. In FIG. 4 execution begins at decision block 110 where a determination is made as to whether or not to base content that is to be generated or otherwise authored on one or more requests received from users of the system. If it is determined at decision block 110 that the content is not to be based upon requests received then execution proceeds directly to decision block 112. Alternatively, if it is determined at decision block 110 that the content that is to be authored or otherwise generated is to be based upon one or more user requests that has been received by the system, execution proceeds to step 114. At step 114 the one or more requests are identified for selection in order to author or otherwise generate the corresponding content. Execution then proceeds directly to decision block 112.

At decision block 112 a determination is made as to whether or not related content is available. If it is determined at decision block 112 that no related content is available, execution proceeds to step 116 for the generation or authoring of the content. Execution then proceeds directly to step 118, where the content is provided or otherwise made available for delivery by the system. Alternatively, if it is determined at decision block 112 that related content is available, execution proceeds to decision block 120 for determination as to whether or not collaboration will take place. If it is determined at decision block 120 that no collaboration is to take place, execution proceeds to step 116 for the generation, creation or authoring of the content. Execution then proceeds to step 118, where the content that has been created, generated or otherwise authored is provided or otherwise made available for delivery through the system. Alternatively, if it is determined at decision block 120 that collaboration is to take place in the generation of content, execution proceeds directly to step 122 where the content collaboration occurs. Execution then proceeds to step 118, where the content that has been created or otherwise generated or authored is provided or otherwise made available for delivery through the system.

At least some embodiments embrace revenue sharing. Individuals are able to communicate through the system about what to do. In one embodiment, the system integrates video conferencing and/or voice over IP capabilities. The individuals use the system to come to terms and to be the intermediary. Upon purchase of the authored content, the system distributes the purchase amount to the individuals according to the agreed upon terms.

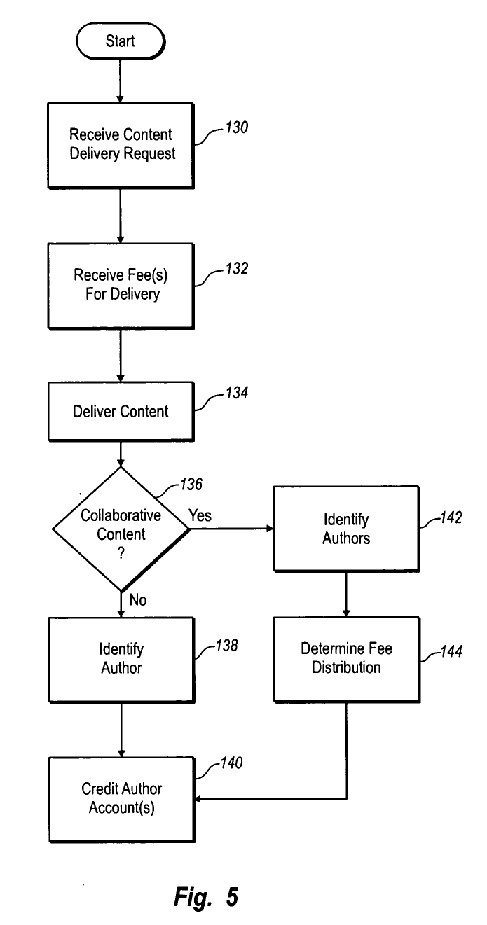

With reference to FIG. 5, a representative embodiment is illustrated for delivering content and allocating fees received for the delivery of the content. In FIG. 5 execution begins at step 130, where a content delivery request is received from a user. Execution then proceeds to step 132, where any associated fees are received in order to enable delivery of the requested content. Execution then proceeds to step 134 for delivery of the content. A determination is then made at decision block 136 as to whether or not the content that has been delivered is collaborative. If it is determined at decision block 136 that the delivered content was not collaborative, execution proceeds to step 138 for identification of the author of the delivered content and then to step 140 for crediting the one or more accounts of the author. Alternatively, if it is determined at decision block 136 that the delivered content was collaborative, execution proceeds to step 142 for identification of the various authors of the collaborative content. At step 144 the feed distribution among the various authors is determined and the author accounts are credited at step 140.

In at least some embodiments, the system provides an electronic channel or forum that is a place where the system displays the wares, allows buyers to run queries for subjects and allows individuals to run queries based on users. For example, Pat bought an article authored, at least in part, by Erik and is interested in other content authored by Erik. Accordingly, Pat is able to view all of the content written by Erik and purchase the content individually or together in one or more compilations.

In some embodiments, buyers and/or authors create virtual books or compilations by joining content. For example, Sue is a buyer that found an article written by Dan and an article written by Samantha. The articles are the two sides of the same issue. Sue realizes that they really belong together and so Sue defines them as a virtual book, or at least a part thereof. Accordingly, individuals through the system are able to aggregate favorite articles or content together. Buyers identify favorite articles and create their virtual books. The books are identified by the system and are made available to other buyers in the electronic community.

In some embodiments, the system provides a reduced purchase price for the purchase of compiled content. For example, the system informs the user that the content, when purchased alone, has a purchase price of a particular amount (i.e., $2.99) but that it is part of a series or compilation that the system is currently sponsoring. And, the series or compilation can be purchased for a discounted amount (i.e., $22.99), which is a 40% discount. The series, for example, provides access to a whole library of information around the particular subject.

In some embodiments, individuals embed links within their articles. Such links are to other articles that they have written and/or other articles in the system that they did not author but are relevant.

In some embodiments, the system includes a reader. A downloadable client is placed on the client computer device within which the user builds a content library, builds their structure of how they store information, and creates their own folder and hierarchies. In a further embodiment, a browser is embedded within the client to enable the shopping experience while online. In one embodiment, an access fee is paid to access content and individual amounts are set to purchase the content.

The system also provides various lists, such as lists of the most popular articles, popular virtual books, and other content. The system further includes a listing of the most popular users and/or authors, including editors, and others that provide a skill set.

In accordance with some embodiments of the present invention, users register into the system and have user profiles within the system. Users register to purchase and/or sell content. Such registration includes, for example, personal information, purchase information, account information for the delivery of monies received from purchases of the individual's authored content, etc. In some embodiments, users do not need to register to view available content or to make content requests. User profiles include, for example, a username, a system sub-domain that maps to a user profile page, etc. The content of the user profile page is user-defined and allows the user to show content authored, favorite content, virtual books or strings of articles, areas of expertise, etc. User profiles are accompanied by a non-optional user ranking system that identifies (i) how other users have ranked this particular user in terms of contribution to other articles, wherein the contribution is based on the role the user played, and (ii) how other users have ranked this particular user's articles in which this particular user is the primary author. Furthermore, all users are registered buyers.

In some embodiments, the authoring requirements include having users agree to licensing terms of the system, being able to access an embedded editor, being able to upload/import pre-existing content to the system in a format that is needed for sales purposes, being able to take content that has been authored and convert it to a particular format, and providing final content format that supports multiple media types. The primary author discovers other users that might have an interest in collaborating. This is facilitated by using the system to help the author find other authors who are writing similar articles, helping the author find individuals (e.g., ghost writers or editors) who have expressed an interest in the author's chosen content category, and using the user profile in the sub-domain to facilitate discovery. In some embodiments, uninvited users are not able to collaborate, the editor identifies who contributed what to the final article, and/or content from a collaborative article is seamlessly exported into the format that will be used for sales purposes. Users can upload/import data that has been composed in any format or available application. Additionally, the content allows for the embedding of image files in article, video, RSS feeds, Flash animation, etc.

In at least some embodiments, the system includes a home page that identifies featured content, a login, marketing material focused on calling new users to register and start buying or authoring, and a search dialogue that helps users search for high-value content. If a search doesn't yield the needed content, a content request dialogue occurs to identify the subject of requested content, any identified parameters, and to submit the request. The submitted request is compared to other requests to see if similar requests have been made. If familiar requests have been made, the requests can be joined.

If at any time a user is browsing or searching content and decides to buy available content, the user can click a “Buy Now” button and their payment information is automatically debited. Monies received from the payment are immediately transferred to the system account and then distributed according to pre-established guidelines between the system and the author(s) of the content.

In accordance with some embodiments of the present invention, all articles have a price, which may be $0, and a primary author. The revenue share that any user receives from the sale of content is a function of the volume of total articles sold by the primary author in a given time period. All content is linkable to any other content of the system. Authors are charged an insertion fee for the content they list in the marketplace. Authors are charged a service fee every time the content is accessed. Content that hasn't been accessed during a period of time is removed from the system.

In at least some embodiments, transactions that occur through the system sync in real-time with a financial software application. Users are able to learn (i) how many times the content has sold, (ii) how much money the authors have made from the content, and/or (iii) how much money the authors have made through the system.

Thus, as discussed herein, the embodiments of the present invention embrace providing an electronic channel for content generation and delivery. In particular, embodiments of the present invention relates to systems and methods for creating and delivering high quality, high value content from among an electronic community of authors, wherein collaboration is enabled and the content is specific to purchasers of the content.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes that come within the meaning and range of equivalency of the claims are to be embraced within their scope.

What is claimed is:

1. A method for providing an electronic channel for content generation and delivery, the method comprising:
receiving a request from a user of a computer device for creation of specific electronic content;
providing said request to at least one author for creation of said specific electronic content;
receiving said specific electronic content as created by said at least one author, wherein said specific electronic content was created based upon said request; and
delivering said specific electronic content received to said computer device upon receipt of a fee amount for said specific electronic content.
